(19) United States
(12) Patent Application Publication
(10) Pub. No.: US 2017/0038772 A1
(43) Pub. Date: Feb. 9, 2017

(54) Modular Robot

(71) Applicant: Gnetic Inc., Palo Alto, CA (US)

(72) Inventors: Gregg Ratanaphanyarat, Palo Alto, CA (US); Dawei Ding, Palo Alto, CA (US)

(21) Appl. No.: 14/937,633

(22) Filed: Nov. 10, 2015

Related U.S. Application Data
(60) Provisional application No. 62/200,814, filed on Aug. 4, 2015.

(51) Int. Cl. G05D 1/00

(52) U.S. Cl. CPC G05D 1/0022; G05D 1/0088; Y10S 901/01; G05D 2201/0203; G05D 2201/0208

(57) ABSTRACT

A modular robot is a robot that is capable of performing a variety of functions and tasks. The robot includes a main body that is driven via a drive system while a steering system controls the direction of movement. An interchangeable attachment may be attached and removed from the main body and includes various components that allow the robot to perform various functions. Electrical power is provided to the robot via a primary power supply and a secondary power supply. An electronic control system allows for autonomous operation of the robot. User commands may be wirelessly received by the electronic control system. The robot is capable of autonomously replacing the primary power supply upon depletion and additionally may be docked to a docking station for charging. The interchangeable attachment may be docked to a docking station as well.

The current application claims a priority to the U.S. Provisional Patent application Ser. No. 62/200,814 filed on Aug. 4, 2015.

### FIELD OF THE INVENTION

The present invention relates generally to a multifunctional robot. More specifically, the present invention is a modular robot that may be configured to perform a variety of functions.

### BACKGROUND OF THE INVENTION

Autonomous robotic platforms are becoming more prevalent among the general public due to their convenience in automating a variety of tasks that are typically completed manually by humans. A simple example of an autonomous robotic platform is a robotic floor cleaner such as a robotic vacuum or a robotic mop. These robotic floor cleaners are able to autonomously traverse across and clean a variety of surfaces. Autonomous robotic platforms are often programmable, allowing users to configure operation times, frequency of operation, and various other settings for the robots. While autonomous robotic platforms are becoming more prevalent, the robots are often designed to perform only a single function, such as cleaning a surface. As a result, it can be quite costly to acquire a dedicated autonomous robotic platform for each task that the user wishes to complete.

The present invention is a modular robot that is capable of performing a variety of functions. The user is able to configure the present invention in order to completely change the functionality of the present invention. The versatility of the present invention allows the present invention to perform a variety of functions without the user being required to acquire a dedicated autonomous robotic platform for each function or task that must be completed.

### BRIEF DESCRIPTION OF THE DRAWINGS

FIG. 1 is a rear elevated perspective view of the present invention.

FIG. 2 is a front elevated perspective view of the present invention.

FIG. 3 is an exploded rear elevated perspective view of the present invention.

FIG. 4 is a rear lowered perspective view of the present invention.

FIG. 5 is a side view of the present invention.

FIG. 6 is a cross-sectional view of the present invention taken along line A-A of FIG. 5.

FIG. 7 is a rear view of the present invention.

FIG. 8 is a cross-sectional view of the present invention taken along line B-B of FIG. 7.

FIG. 9 is a diagram depicting electronic connections of the present invention.

FIG. 10 is a diagram depicting electrical connections of the present invention for the primary power supply.

FIG. 11 is a diagram depicting electrical connections of the present invention for the secondary power supply.

FIG. 12 is a rear lowered perspective view of the present invention, wherein the interchangeable attachment is a steam cleaner.

FIG. 13 is a rear lowered perspective view of the present invention, wherein the interchangeable attachment is a lawnmower.

FIG. 14 is a rear lowered perspective view of the present invention, wherein the interchangeable attachment is a tertiary power supply.

FIG. 15 is a diagram depicting electrical connections for the tertiary power supply.

### DETAIL DESCRIPTIONS OF THE INVENTION

All illustrations of the drawings are for the purpose of describing selected versions of the present invention and are not intended to limit the scope of the present invention.

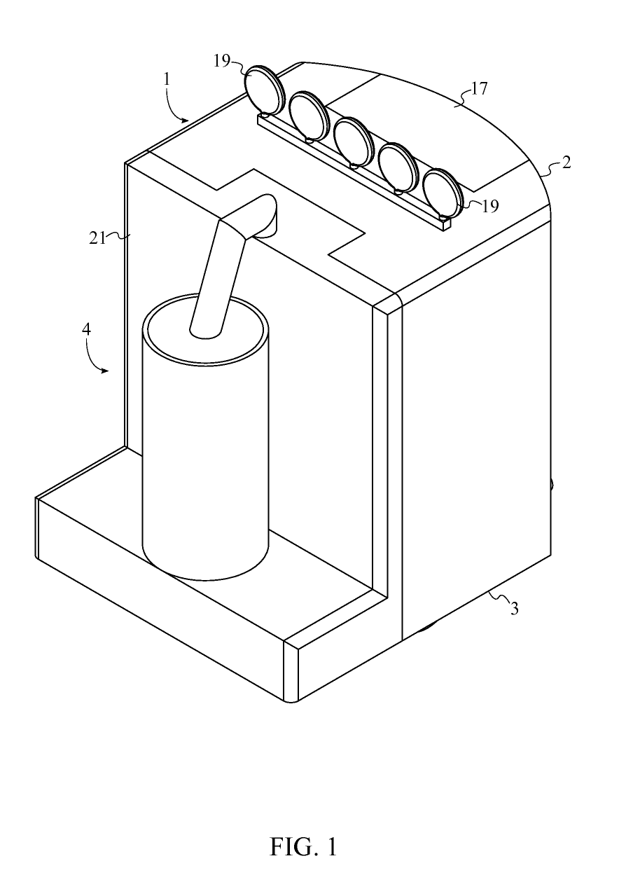

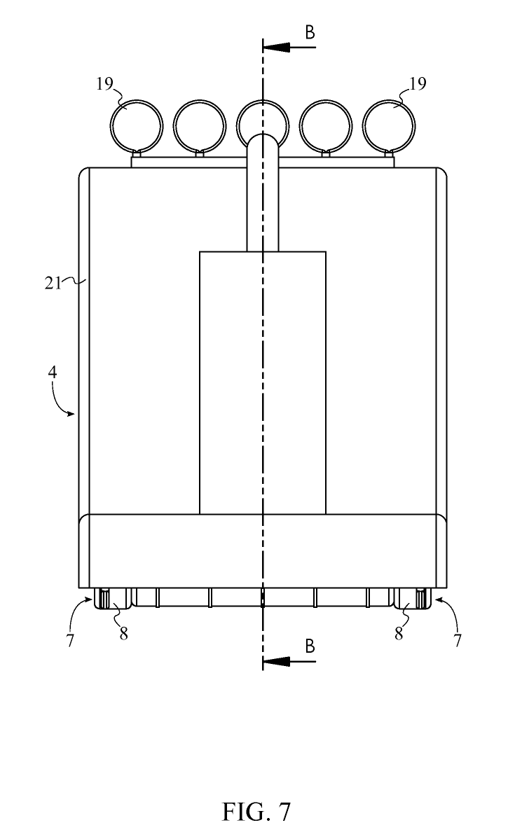

The present invention is a modular robot that is configurable to perform a variety of functions. The present invention is shown in FIGS. 1-11 and comprises a main body 1, an interchangeable attachment 4, a drive system 7, a steering system 10, an electronic control system 13, and a primary power supply 17.

The main body 1 is the base component onto and within which the remaining components of the present invention are situated. The drive system 7 provides mobility to the present invention across a surface. The drive system 7 is mounted to the main body 1, adjacent to a base end 3 of the main body 1. This allows the main body 1 to travel across a surface via the drive system 7. The steering system 10 allows the present invention to navigate across a surface and enables functions such as turning and changing the direction of travel of the present invention. The steering system 10 is mounted to the main body 1, offset from the drive system 7. As such, the steering system 10 is able to change the lateral direction in which the present invention is moving when moving in a forward direction as well as a backward direction.

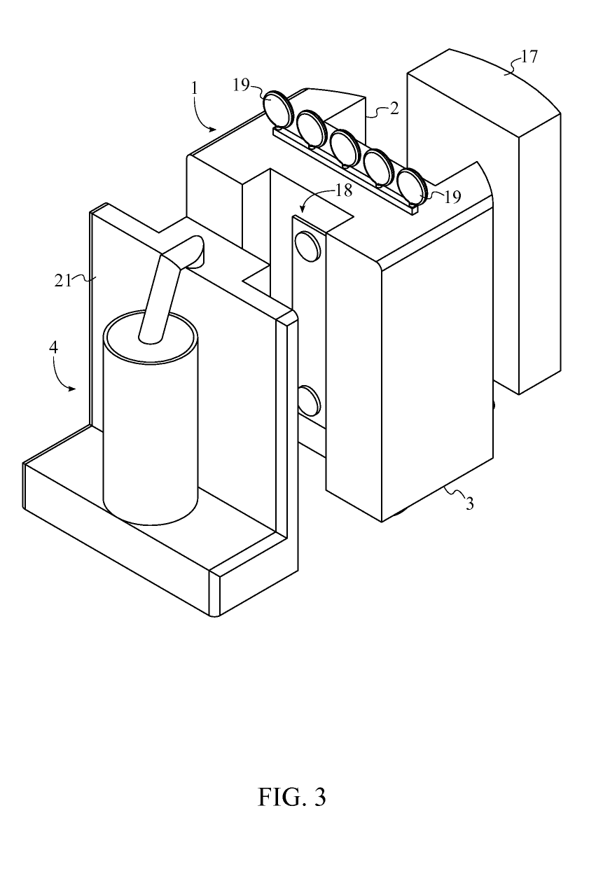

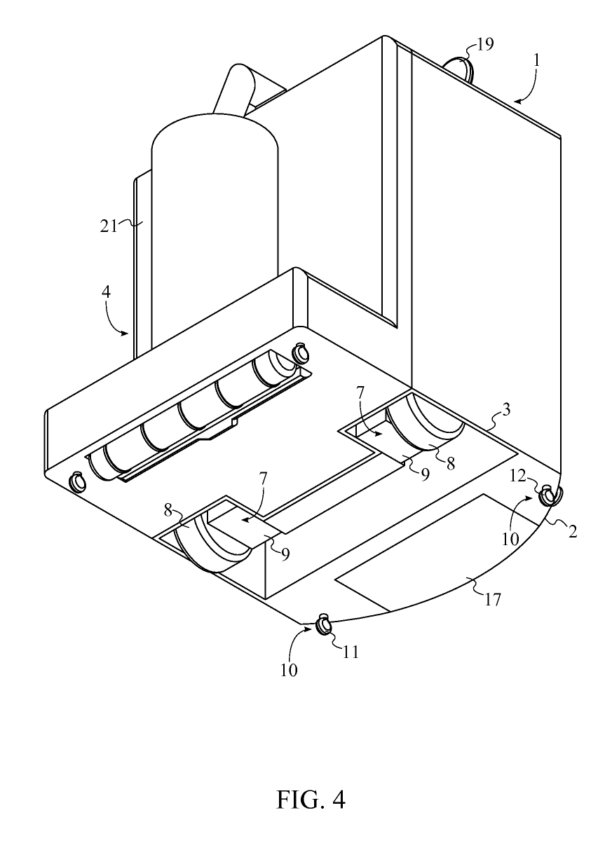

The interchangeable attachment 4 provides a level of modularity to the present invention. The interchangeable attachment 4 allows the functionality and utility of the present invention to be entirely changed. As shown in FIG. 3 and FIG. 4, the interchangeable attachment 4 is removably mounted to the main body 1, adjacent to the drive system 7. This allows the interchangeable attachment 4 to be removed and replaced in order to alter the functionality of the present invention.

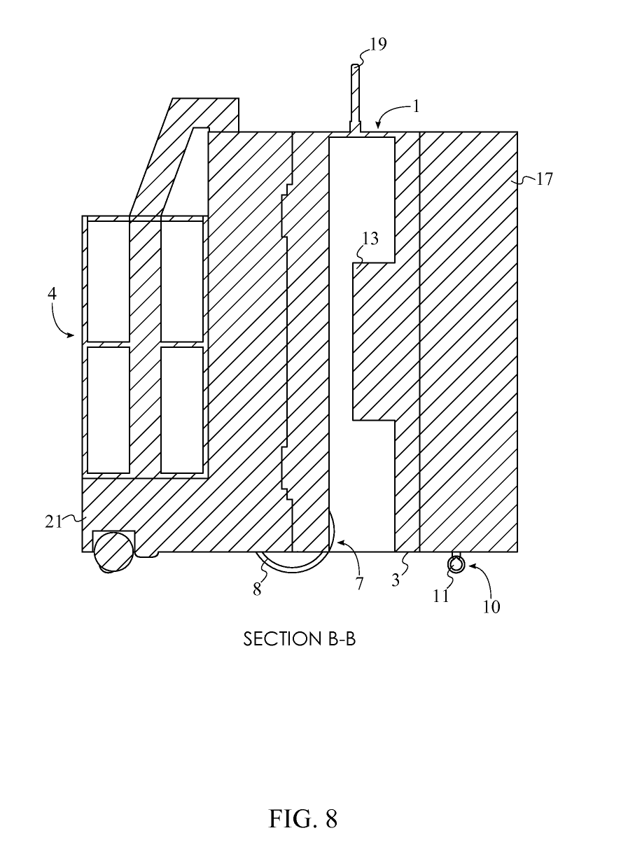

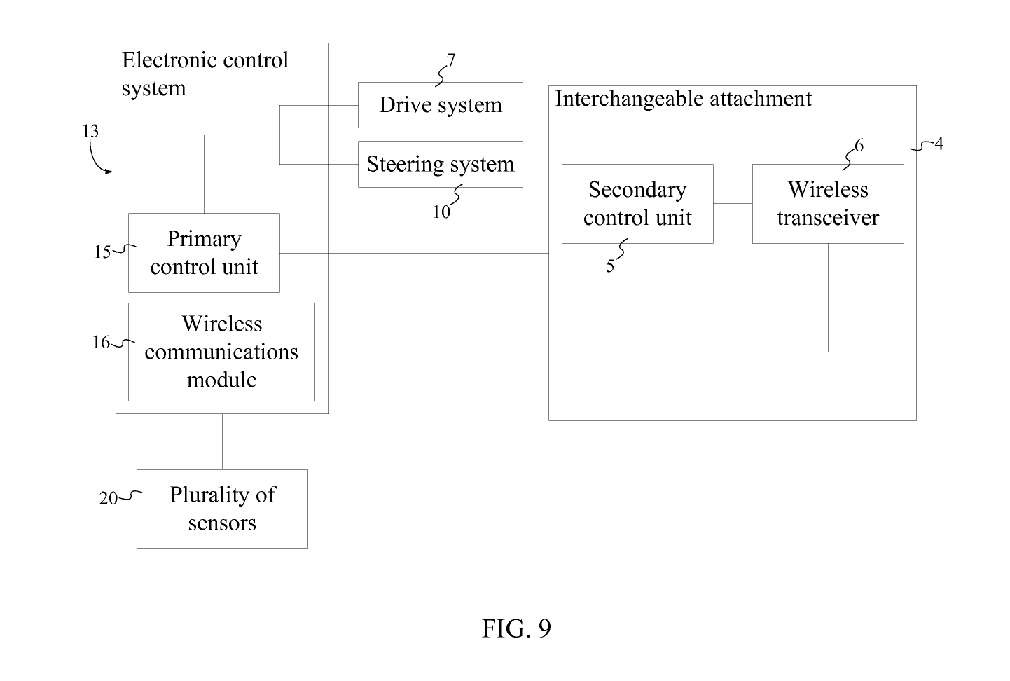

The electronic control system 13 is able to control the present invention during operation. The electronic control system 13 is mounted within the main body 1 as shown in FIG. 8, adjacent to the drive system 7. Electronic connections for the electronic control system 13 are shown in FIG. 9. The electronic control system 13 is thus protected within the main body 1 from the external environment. Additionally, the electronic control system 13 may be easily wired to the drive system 7 and the steering system 10, or alternatively, control may be wirelessly established. The electronic control system 13 is additionally able to communicate with the interchangeable attachment 4 in order to regulate the various functions of the present invention that are available via the interchangeable attachment 4. As such, the electronic control system 13 is electronically connected to the drive system 7, the steering system 10, and the interchangeable attachment 4 in order to enable the electronic control system 13 to regulate the drive system 7, the steering system 10, as well as the interchangeable attachment 4 during operation of the present invention.

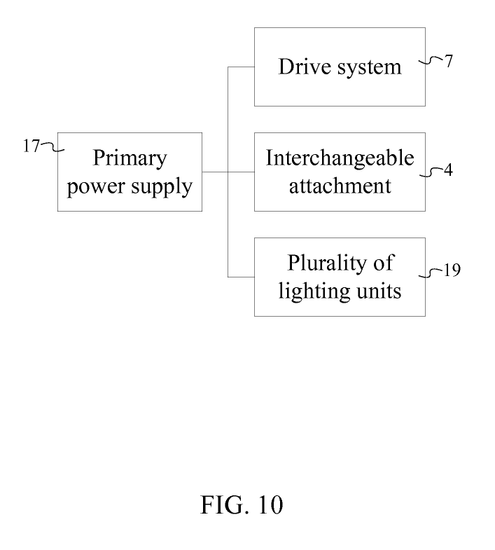

The primary power supply 17 provides electrical power to the present invention. Again referring to FIG. 3, the primary power supply 17 is externally and removably mounted to the main body 1, opposite to the interchangeable attachment 4. This allows the primary power supply 17 to be easily removed from the main body 1 and replaced when the primary power supply 17 is depleted. A mechanism for fastening the primary power supply 17 in place on the main body 1 may be present in order to ensure that the primary power supply 17 is securely in place. The primary power supply 17 is additionally positioned in a manner such that the primary power supply 17 may be recharged without removing the primary power supply 17 from the main body 1 by docking the present invention to a charging station. As shown in FIG. 10, the primary power supply 17 is electrically connected to the drive system 7 and the interchangeable attachment 4, providing electrical power to transport the present invention as well as to perform a variety of functions.

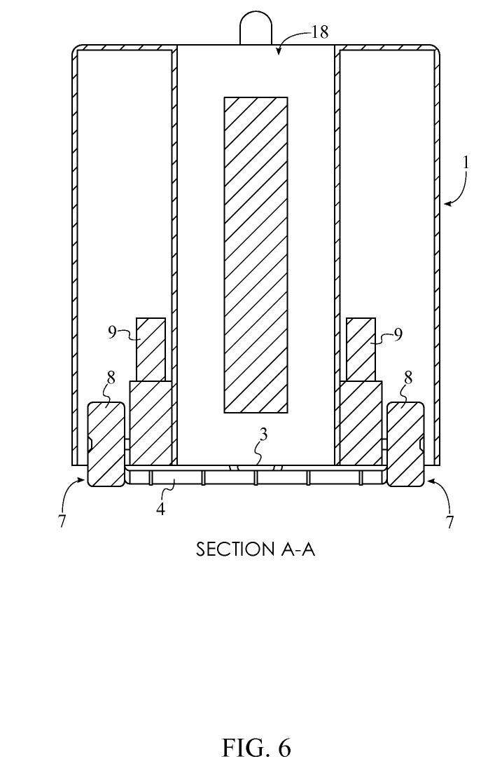

In its preferred embodiment, the present invention further comprises an attachment retention channel 18 as shown in FIG. 3 and FIG. 6. The attachment retention channel 18 enables the interchangeable attachment 4 to be mounted to the main body 1 and is able to securely hold the interchangeable attachment 4 in place during operation of the present invention. The attachment retention channel 18 traverses through the main body 1, opposite to the primary power supply 17. This provides a cavity into which the interchangeable attachment 4 may be mounted. The interchangeable attachment 4 is operatively engaged into the attachment retention channel 18. This allows the attachment retention channel 18 to be used to structurally secure the interchangeable attachment 4 and the interchangeable attachment 4 to be easily removed from the main body 1 when altering the functionality of the present invention. The attachment retention channel 18 may include a mechanism for securing the interchangeable attachment 4 in place once the interchangeable attachment 4 is mounted. Additionally, the attachment retention channel 18 may include sensors to ensure that the interchangeable attachment 4 is properly aligned for mounting.

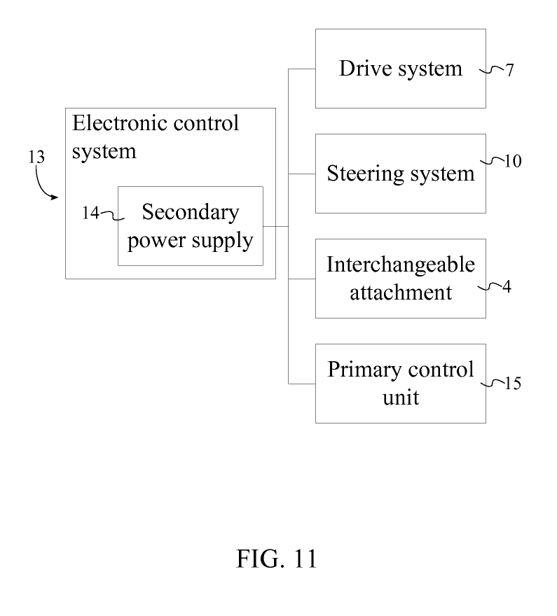

Again with reference to FIG. 9 and FIG. 11, the electronic control system 13 comprises a secondary power supply 14, a primary control unit 15, and a wireless communications module 16. Additionally, the interchangeable attachment 4 comprises a secondary control unit 5 and a wireless transceiver 6. The secondary power supply 14 provides electrical power to the electronic control system 13 and as such is electrically connected to the drive system 7, the steering system 10, the interchangeable attachment 4, and the primary control unit 15. The secondary power supply 14 provides electrical power to the drive system 7, the steering system 10, and the interchangeable attachment 4 in order to enable the present invention to remain operational while the primary power supply 17 is being replaced upon depletion. The secondary power supply 14 additionally enables the present invention itself to replace the primary power supply 17 by providing electrical power and keeping the present invention operational when the primary power supply 17 is depleted.

The primary control unit 15 is able to control the drive system 7 and the steering system 10, as well as the interchangeable attachment 4 through the secondary control unit 5. The wireless communications module 16 and the wireless transceiver 6 enable wireless communication between the electronic control system 13 and the interchangeable attachment 4. Additionally, the wireless communications module 16 allows the electronic control system 13 to receive commands from an external source such as a user computing device through Wi-Fi. The wireless communications module 16 thus enables remote user control of the present invention. The wireless communications module 16 is communicatively coupled to the wireless transceiver 6 and as such, commands may be wirelessly transmitted from the electronic control system 13 to the interchangeable attachment 4. The wireless transceiver 6 is electronically connected to the secondary control unit 5. Commands that are wirelessly received from the electronic control system 13 may thus be implemented through the secondary control unit 5, allowing the electronic control system 13 to wirelessly control the interchangeable attachment 4. The wireless transceiver 6 additionally enables the interchangeable attachment 4 to wirelessly communicate with another interchangeable attachment 4. The wireless communications module 16 and the wireless transceiver 6 additionally allow for system updates to be downloaded and applied to the primary control unit 15 and the secondary control unit 5. System updates may be accepted and implemented wirelessly through a user computing device.

As shown in FIG. 4, the drive system 7 comprises a pair of drive wheels 8 and at least one motor 9. The pair of drive wheels 8 allows the present invention to traverse across a surface while the at least one motor 9 converts electrical energy from the primary power supply 17 and the secondary power supply 14 to mechanical energy. The pair of drive wheels 8 is torsionally connected to the at least one motor 9, enabling rotation of the pair of drive wheels 8 due to mechanical energy provided by the at least one motor 9. In the preferred embodiment of the present invention, the pair of drive wheels 8 is a pair of geared wheels. Additionally, in the preferred embodiment of the present invention, the at least one motor 9 is a first motor and a second motor. As such, each drive wheel from the pair of drive wheels 8 is driven by its own motor. The specific location of the pair of drive wheels 8 on the main body 1 may vary as well. In the preferred embodiment of the present invention, the at least one motor 9 includes a gearbox as well as one or more sensors. The gearbox is able to alter the torque output of the at least one motor 9 while the sensors are able to monitor the at least one motor 9 as well as relay data to the electronic control system 13.

With continued reference to FIG. 4, the steering system 10 comprises a first rotatable wheel 11 and a second rotatable wheel 12. The first rotatable wheel 11 and the second rotatable wheel 12 enable the present invention to change direction when traveling across a surface. The first rotatable wheel 11 is mounted to the base end 3, opposite to the drive system 7 along the base end 3. Similarly, the second rotatable wheel 12 is mounted to the base end 3, opposite to the first rotatable wheel 11 on the base end 3. The first rotatable wheel 11 and the second rotatable wheel 12 are thus offset from the drive system 7 and are able to alter the lateral direction of movement for the present invention. The electronic control system 13 is able to aid in navigation of the present invention through the first rotatable wheel 11 and the second rotatable wheel 12. In the preferred embodiment of the present invention, the first rotatable wheel 11 and the second rotatable wheel 12 are caster wheels.

In various embodiments of the present invention, a first tread is wrapped around one wheel from the pair of drive wheels 8 and the first rotatable wheel 11, and a second tread is wrapped around the other wheel from the pair of drive wheels 8. When present, these treads enable the present invention to traverse across tougher terrain such as snow and ice. The present invention is thus provided similar mobility as that of a tank.

As shown in FIGS. 1-3, the present invention further comprises a plurality of lighting units 19. The plurality of lighting units 19 provides illumination within the vicinity of the present invention. The plurality of lighting units 19 is mounted to the main body 1, opposite to the base end 3. The plurality of lighting units 19 may be adjustable from side to side or up and down. Additionally, the plurality of lighting units 19 may be able to provide illumination in multiple directions simultaneously. As shown in FIG. 10, the plurality of lighting units 19 is electrically connected to the primary power supply 17, enabling the primary power supply 17 to provide electrical power to the plurality of lighting units 19. The specific location of the plurality of lighting units 19 may vary across embodiments of the present invention in order to suit the functionality and design of the present invention. For example, the plurality of lighting units 19 may be a plurality of light-emitting diodes (LEDs) that are directly built into the main body 1.

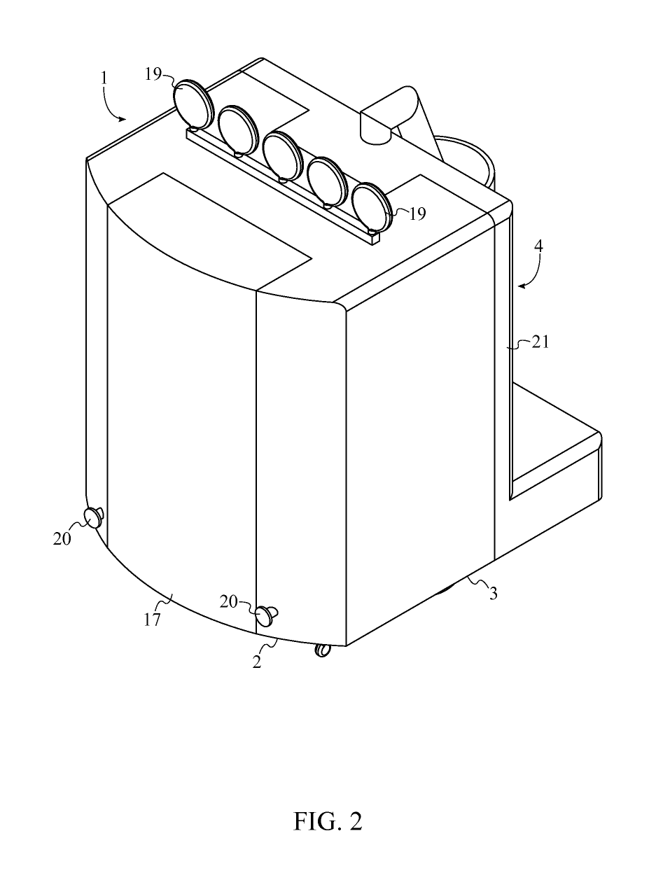

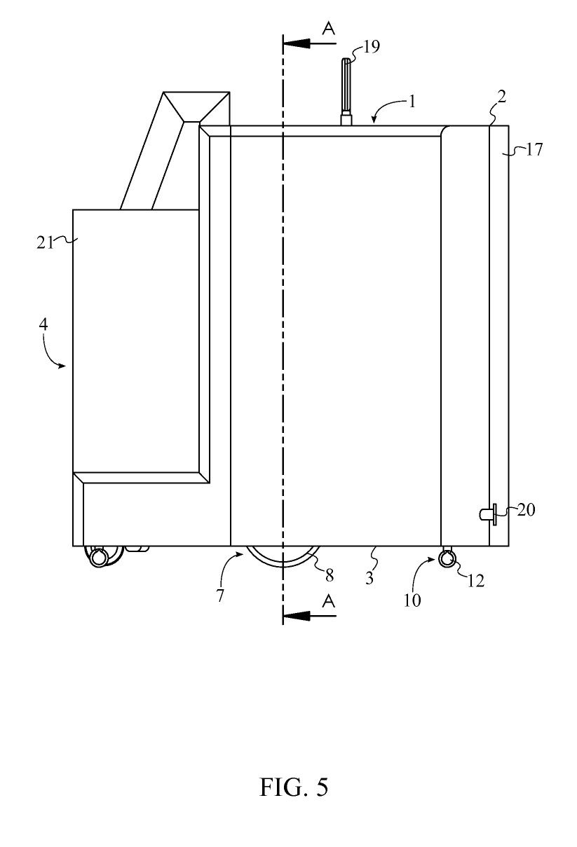

Because the present invention is capable of autonomous operation, it is important that the present invention does not become stuck, damaged, or otherwise compromised during operation. As such, the present invention further comprises a plurality of sensors 20 as shown in FIG. 2 and FIG. 5. The plurality of sensors 20 facilitates the autonomous operation of the present invention by assisting in the movement of the present invention. In the preferred embodiment of the present invention, the plurality of sensors 20 is a plurality of collision detection sensors. The plurality of collision detection sensors is thus able to detect if the present invention is about to come into contact with an object, enabling actions to be taken to prevent a collision such as steering away from the object. The plurality of collision detection sensors 25 may include at least one camera to provide a live view of the vicinity of the present invention. The plurality of sensors 20 is positioned on a front end 2 of the main body 1, enabling the plurality of sensors 20 to detect an object in front of the present invention as the present invention is traveling across a surface. The plurality of sensors 20 is electronically connected to the electronic control system 13. As such, the plurality of sensors 20 is able to communicate with the electronic control system 13 as shown in FIG. 9, allowing the electronic control system 13 to take actions to avoid a collision. The present invention may additionally include a bumper for absorbing impacts. Additional sensors such as bump sensors may be included in order to determine if the present invention has made contact with an object.

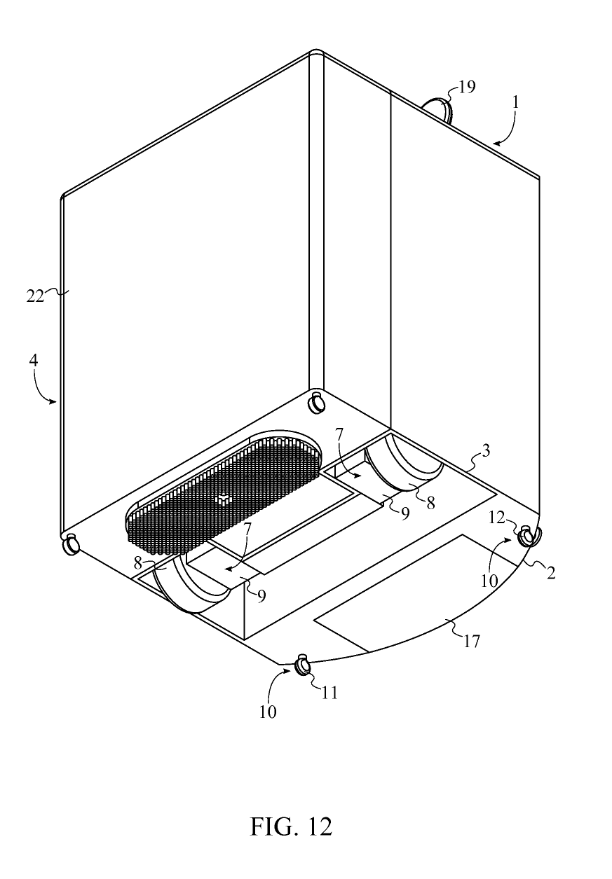

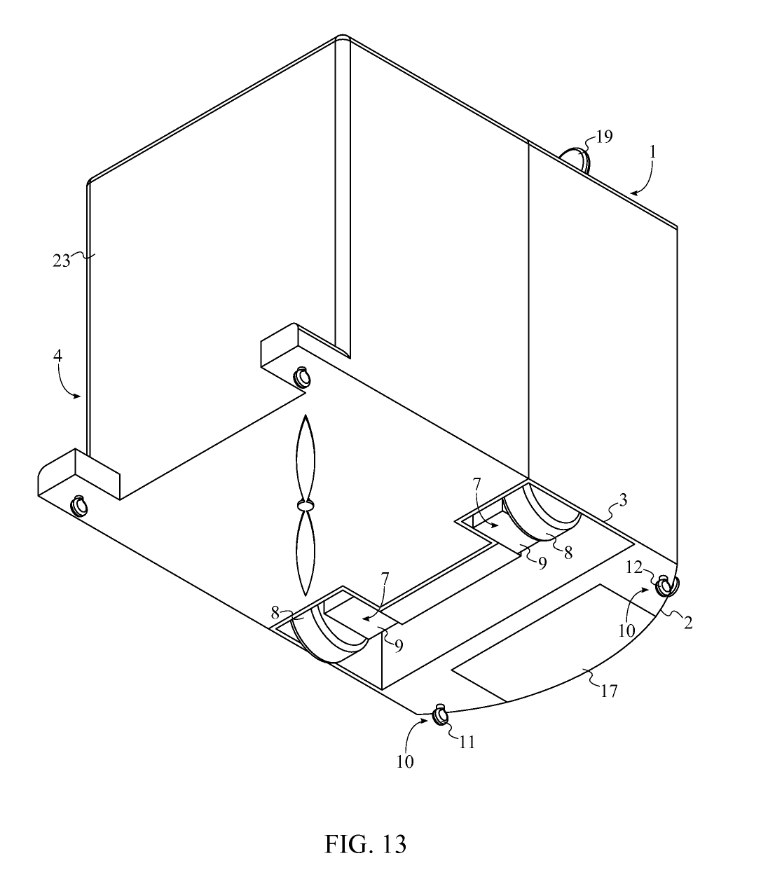

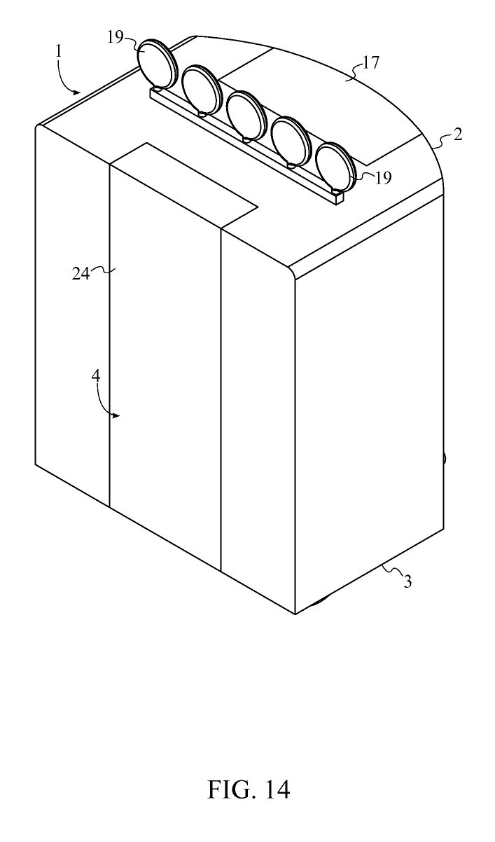

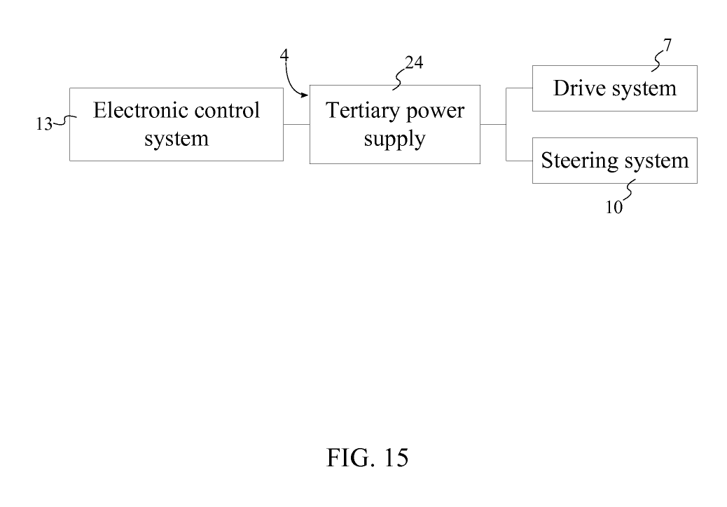

The embodiment of the present invention shown in FIGS. 1-8 includes an interchangeable attachment 4 that serves as a vacuum cleaner 21. The vacuum cleaner 21 may be utilized to remove dust, debris, and other small objects from a surface as the present invention travels across the surface. Several additional examples of the interchangeable attachment 4 are shown in FIGS. 12-15. In the example shown in FIG. 12, the interchangeable attachment 4 is a steam cleaner 22. The steam cleaner 22 is able to clean a surface as the present invention travels across the surface. The example in FIG. 13 shows an interchangeable attachment 4 that serves as a lawnmower 23. The lawnmower 23 is capable of cutting excessive plant growth while traveling across a surface. In the final example shown in FIG. 14 and FIG. 15, the interchangeable attachment 4 is a tertiary power supply 24. The tertiary power supply 24 is able to continue providing electrical power to the present invention beyond the capacity provided by the primary power supply 17 and the secondary power supply 14. The tertiary power supply 24 is electrically connected to the drive system 7, the steering system 10, and the electronic control system 13 to enable the present invention to remain operational. Because the functionality of the present invention may be entirely altered via the interchangeable attachment 4, it is understood that the interchangeable attachment 4 may comprise additional components that are required to perform various functions. For example, in the case of the lawnmower 23, the interchangeable attachment 4 includes a motor as well as an attached blade. It is also understood that the shape and overall design of the interchangeable attachment 4 may vary as well according to the functionality of the interchangeable attachment 4. Additional example applications of the present invention include, but are not limited to, road painting, transporting goods, and ice resurfacing. The present invention may additionally be utilized for military applications such as chemical detection, mine detection, and explosive ordnance disposal (EOD). Finally, the interchangeable attachment 4 may be an adapter that allows the present invention to pick up virtually any object that the adapter is designed to accommodate. Example objects that may be picked up via the adapter include, but are not limited to, garbage containers and clothes bins.

The electronic control system 13 may further comprise a digital display for enabling the user to view various settings and properties of the present invention. The digital display may incorporate touch technology for user input into the electronic control system 13 or alternatively, a physical input device such as a keypad may be present. The user is thus able to input commands as well as configure the electronic control system 13 as well as the interchangeable attachment 4. The electronic control system 13 may further incorporate a microphone to enable the user to input voice commands during operation of the present invention. A data storage device may be present as well to allow data collected during operation of the present invention to be saved. The data storage device may or may not be removable from the present invention. Data storage ports such as Universal Serial Bus (USB) ports may be present to facilitate data transfer or to allow the present invention to be connected to an external computing device. Additionally, the present invention may further include a charging port to allow the present invention to be physically connected to an external power source for charging. Finally, the electronic control system 13 may feature a camera that allows the user to view the surrounding environment during operation of the present invention. The camera may be utilized in conjunction with the plurality of sensors 20 to aid in the autonomous operation of the present invention. The camera may be utilized to detect objects, colors, and additional visual factors that aid in autonomous operation of the present invention. For example, the color green may correspond to grassy terrain while the color blue may correspond to water, allowing the present invention to steer away from the water and remain on the grassy terrain. The camera may additionally include infrared imaging, night vision, and/or similar imaging technologies.

As previously discussed, because the primary power supply 17 is externally mounted to the main body 1, the present invention is capable of replacing the primary power supply 17 autonomously in lieu of manual replacement by the user. The present invention may be utilized in conjunction with a docking station or similar structure for charging and/or replacing the primary power supply 17. The present invention is able to autonomously dock with the docking station in order to charge the primary power supply 17. The interchangeable attachment 4 may be docked to and charged at the docking station as well. This allows the secondary power supply 14 to be charged via the docking station in addition to the primary power supply 17.

Although the present invention has been explained in relation to its preferred embodiment, it is understood that many other possible modifications and variations can be made without departing from the spirit and scope of the present invention as hereinafter claimed.

What is claimed is:

1. A modular robot comprises:
a main body;
an interchangeable attachment;
a drive system;
a steering system;
an electronic control system;
a primary power supply;
the drive system being mounted to the main body, adjacent to a base end of the main body;
the steering system being mounted to the main body, offset from the drive system;
the interchangeable attachment being removably mounted to the main body, adjacent to the drive system;
the electronic control system being mounted within the main body, adjacent to the drive system;
the electronic control system being electronically connected to the drive system, the steering system, and the interchangeable attachment;
the primary power supply being externally and removably mounted to the main body, opposite to the interchangeable attachment; and
the primary power supply being electrically connected to the drive system and the interchangeable attachment.

2. The modular robot as claimed in claim 1 further comprises:
an attachment retention channel;
the attachment retention channel traversing through the main body, opposite to the primary power supply; and
the interchangeable attachment being operatively engaged into the attachment retention channel, wherein the attachment retention channel is used to structurally secure the interchangeable attachment.

3. The modular robot as claimed in claim 1 further comprises:
the electronic control system comprises a secondary power supply, a primary control unit, and a wireless communications module;
the interchangeable attachment comprises a secondary control unit and a wireless transceiver;
the secondary power supply being electrically connected to the drive system, steering system, the interchangeable attachment, and the primary control unit;
the wireless communications module being communicatively coupled to the wireless transceiver; and
the wireless transceiver being electronically connected to the secondary control unit.

4. The modular robot as claimed in claim 1 further comprises:
the drive system comprises a pair of drive wheels and at least one motor; and
the pair of drive wheels being torsionally connected to the at least one motor.

5. The modular robot as claimed in claim 1 further comprises:
the steering system comprises a first rotatable wheel and a second rotatable wheel;
the first rotatable wheel being mounted to the base end, opposite to the drive system along the base end; and
the second rotatable wheel being mounted to the base end, opposite to the first rotatable wheel on the base end.

6. The modular robot as claimed in claim 1 further comprises:
a plurality of lighting units;
the plurality of lighting units being mounted to the main body, opposite to the base end; and
the plurality of lighting units being electrically connected to the primary power supply.

7. The modular robot as claimed in claim 1 further comprises:
a plurality of sensors;
the plurality of sensors being positioned on a front end of the main body; and
the plurality of sensors being electronically connected to the electronic control system.

8. The modular robot as claimed in claim 7, wherein the plurality of sensors is a plurality of collision detection sensors.

9. The modular robot as claimed in claim 1, wherein the interchangeable attachment is a steam cleaner.

10. The modular robot as claimed in claim 1, wherein the interchangeable attachment is a vacuum cleaner.

11. The modular robot as claimed in claim 1, wherein the interchangeable attachment is a lawnmower.

12. The modular robot as claimed in claim 1, wherein the interchangeable attachment is a tertiary power supply.

13. The modular robot as claimed in claim 12 further comprises:
the tertiary power supply being electrically connected to the drive system, the steering system, and the electronic control system.

14. A modular robot comprises:
a main body;
an interchangeable attachment;
a drive system;
a steering system;
an electronic control system;
a primary power supply;
a plurality of sensors;
the drive system being mounted to the main body, adjacent to a base end of the main body;
the steering system being mounted to the main body, offset from the drive system;
the interchangeable attachment being removably mounted to the main body, adjacent to the drive system;
the electronic control system being mounted within the main body, adjacent to the drive system;
the electronic control system being electronically connected to the drive system, the steering system, and the interchangeable attachment;
the primary power supply being externally and removably mounted to the main body, opposite to the interchangeable attachment;
the primary power supply being electrically connected to the drive system and the interchangeable attachment;
the plurality of sensors being positioned on a front end of the main body;
the plurality of sensors being electronically connected to the electronic control system; and
the plurality of sensors being a plurality of collision detection sensors.

15. The modular robot as claimed in claim 14 further comprises:
an attachment retention channel;
the attachment retention channel traversing through the main body, opposite to the primary power supply; and
the interchangeable attachment being operatively engaged into the attachment retention channel, wherein the attachment retention channel is used to structurally secure the interchangeable attachment.

16. The modular robot as claimed in claim 14 further comprises:
the electronic control system comprises a secondary power supply, a primary control unit, and a wireless communications module;
the interchangeable attachment comprises a secondary control unit and a wireless transceiver;
the secondary power supply being electrically connected to the drive system, steering system, the interchangeable attachment, and the primary control unit;
the wireless communications module being communicatively coupled to the wireless transceiver; and
the wireless transceiver being electronically connected to the secondary control unit.

17. The modular robot as claimed in claim 14 further comprises:
the drive system comprises a pair of drive wheels and at least one motor;
the steering system comprises a first rotatable wheel and a second rotatable wheel;
the pair of drive wheels being torsionally connected to the at least one motor;
the first rotatable wheel being mounted to the base end, opposite to the drive system along the base end; and
the second rotatable wheel being mounted to the base end, opposite to the first rotatable wheel on the base end.

18. The modular robot as claimed in claim 14 further comprises:
a plurality of lighting units;
the plurality of lighting units being mounted to the main body, opposite to the base end; and
the plurality of lighting units being electrically connected to the primary power supply.

19. The modular robot as claimed in claim 14, wherein the interchangeable attachment is an appliance selected from the group consisting of: a steam cleaner, a vacuum cleaner, and a lawnmower.

20. The modular robot as claimed in claim 14 further comprises:
the interchangeable attachment being a tertiary power supply; and
the tertiary power supply being electrically connected to the drive system, the steering system, and the electronic control system.
